(19) United States
(12) Patent Application Publication
(10) Pub. No.: US 2007/0299998 A1
(43) Pub. Date: Dec. 27, 2007

(54) Method and System for Facilitating Faster Data Transmission between a Central Processing Unit and a Connected Memory Device

(76) Inventors: Mordechay Beck, Cupertino, CA (US); Dan Kikinis, Saratoga, CA (US)

Correspondence Address: CENTRAL COAST PATENT AGENCY, INC, 3 HANGAR WAY SUITE D, WATSONVILLE, CA, 95076, US

(21) Appl. No.: 11/767,062

(22) Filed: Jun. 22, 2007

Related U.S. Application Data
(63) Continuation of application No. 60/805,716, filed on Jun. 23, 2006.

(51) Int. Cl. G06F 13/40

(52) U.S. Cl. 710/104

(57) ABSTRACT

In a computer bus architecture, a system for improving performance in data transmitting between bussed devices includes a processor connected to the bus architecture; at least one memory device bussed to the processor; a circuit on the processor for reducing the number of bus lines required for transmitting data; and a circuit on each of the at least one memory device for reconstructing the bussed signal.

### CROSS-REFERENCE TO RELATED APPLICATIONS

The present invention claims priority to a U.S. provisional patent application Ser. No. 60/805,716, entitled “Method and System for Improved Data Transmission Between CPE and Memory Devices”, filed on Jun. 23, 2006 disclosure of which is included herein by reference.

### BACKGROUND OF THE INVENTION

1. Field of the Invention:

The present invention is in the field of computer processing devices and connected memory devices and pertains particularly to improving the speed of data transmission between a CPU and a memory device.

2. Discussion of the State of the Art:

With the advent of higher speed central processing units (CPUs) for computer devices and larger memory busses associated with data transmission to connected memory devices, more chip real estate is required to facilitate data transfer from CPUs to bus connected memory devices and graphics cards.

FIG. 1 illustrates a typical prior art example of a CPU connected to one or more memory devices by a memory bus structure, also referred to in the art as a local bus or a system bus. CPU 101 typically includes a control interface 104a and a memory bus driver 105a. In a typical computer model, one or more memory devices not resident on the CPU may be connected or bussed for communication to the CPU. A memory device 102 and a memory device 103 are illustrated in this example. Like CPU 101, device 102 and device 103 each include a control interface and a bus driver. Device 102 has control interface 104b and driver 105b while device 103 includes control interface 104c and driver 105c.

Memory devices 102 and 103 may include but are not limited to graphics devices or cards. Network adaptors or cards, disk controllers or cards, video cards, or other components containing memory elements accessible to CPU 101. Typically a 64-bit/128-bit or 256-bit wide memory bus is provided to interface the memory devices with the CPU. Each device and the CPU have the required drivers and circuitry enabling, typically bi-directional communication with the CPU over the bus architecture. The CPU has a control line (illustrated logically for separation) from its control interface 104a to each memory device connected at respective control interfaces 104b for device 102 and 104c for device 103. In a typical implementation a control line is used to control how and where (addressing) in memory data will be delivered to a device as is well known in the computing arts. In this case, the control line is typically 4 to 16 bits wide. While the data width of the bus in this example is typical, a memory bus may be wider than 256 bits. Some recently designed systems have wider busses at 512 bits or more.

Conventionally, parallel data transmission across a bus structure requires a separate data line for every dynamic random access (DRAM) module. The speed of transmission is good across the bus structure, but it operates at typically half or less the speed that the CPU is capable of processing data. Moreover, bottlenecks may occur at the interface of the bus structure to the memory module. One thing is consistent with parallel bus structures, and that is the wider the bus (more lines) is the more pins are required at the memory controller.

More recently, a new type of dual inline memory module (DIMM) has been developed that is fully buffered and referred to in the art as an FB DIMM. The FB DIMM sits behind a buffer located between the CPU and the device(s). A serial interface is provided in the FB DIMM architecture to increase data transfer speed enabling a reduction in the number of pins used to connect the devices for communication. Freeing up space on the memory controller enables the addition of a second memory bus.

A problem with this concept is that any additional FB DIM connected to the bus sits behind the buffer and as a result suffers some loss of performance. Due to the higher data transfer speeds employed; signals are transmitted on pairs of lines. A controller chip (FB) resides on each FB DIMM. The FB DIMM uses standard memory chips.

What is clearly needed in the art is a method and system that can improve the speed of transfer of data between a CPU and a main and or peripheral memory device without requiring any complex buffering components or additional complex chips on the memory device. Moreover, a system such as this could be distributed partly on a CPU and partly on a memory device for a more balanced data transmit solution.

### SUMMARY OF THE INVENTION

In a computer bus architecture, a system is provided for improving performance in data transmitting between bussed devices. The system includes a processor connected to the bus architecture; at least one memory device bussed to the processor; a circuit on the processor for reducing the number of bus lines required for transmitting data; and a circuit on each of the at least one memory device for reconstructing the bussed signal.

In one embodiment, the processor is a central processing unit and the memory device is one or more than one of a single inline memory module or a dual inline memory module. In another embodiment, the processor is a central processing unit and the memory device is one or more than one of a network adaptor, graphics accelerator port, or video graphics array capture card.

In another embodiment, the processor is a central processing unit and there is more than one memory device, the devices comprising a combination of dual inline memory devices and peripherally bussed memory devices. In still another embodiment, the processor is a central processing unit and there is more than one memory device, the devices comprising combination of single inline memory devices and peripherally bussed memory devices.

In one embodiment, the circuit on the processor is a quadrature amplitude modulation circuit and the circuit on the memory device is a quadrature amplitude demodulation circuit. In this embodiment, phase modulation reduces the number of lines required to transmit the data.

In another embodiment, the circuit on the central processor is a digital-to-analog converter and the circuit on the memory device is an analog-to-digital converter. In this embodiment, digital-to-analog conversion reduces the number of lines required to transmit the data.

According to another aspect of the present invention, in a computer bus architecture, a method is provided for improving performance of data transmitting between bussed devices. The method includes the steps (a) inputting data into a bus compression circuit on one of the bussed devices, (b) reducing the data transmission to fewer lines, (c) transmitting data over the reduced number of lines to another of the bussed devices, and (d) receiving the data at the device of step (c) and decompressing the bus.

In one aspect of the method in step (a), the bus compression circuit is a quadrature amplitude modulation circuit and the device is a central processing unit. In another aspect of the method in step (a), the circuit is a digital-to-analog converter and the device is a central processing unit. In the first aspect, in step (b), reducing the transmission to fewer lines is accomplished by phase modulation. In the second aspect, in step (b), reducing the transmission to fewer lines is accomplished by digital-to-analog conversion.

In one aspect, in step (c), the device is a VGA capture card with an analog to digital converter. In this aspect, in step (d), a half step voltage drop is used to clean up the signal when reconstructing the bus.

In one embodiment relative to the system of the invention including the modulator and demodulator circuitry, the demodulator circuit receives the data, the control signals, and a clock signal to maintain phase alignment with the modulator circuit on the processor. In one embodiment relative to the broader system, the computer bus architecture includes one or a combination of a local bus, a peripheral component interconnect bus, an accelerated graphics port bus, or a Scuzzy (SCSI) bus.

In one embodiment relative to the system using digital-to-analog and analog-to-digital circuitry, the memory device is a video display capture card having an analog-to-digital converter with a half step voltage offset for reducing noise in the reconstructed digital signal.

### BRIEF DESCRIPTION OF THE DRAWING FIGURES

FIG. 1 is a block diagram illustrating a CPU memory bus and connected devices according to prior art.

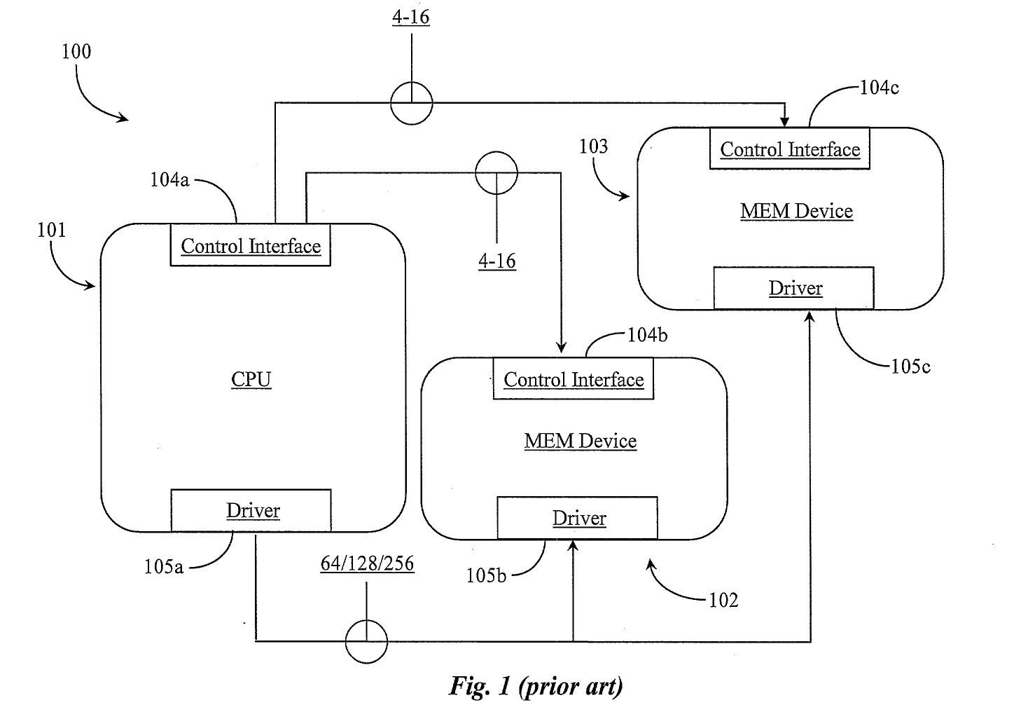

FIG. 2 is a block diagram illustrating a CPU memory bus structure and system according to an embodiment of the present invention.

FIG. 3 is a process flow chart illustrating steps for error correction using the bus modulation system of the present invention.

FIG. 4 is a block diagram illustrating a version of the system for implementation in a liquid crystal display example using a video graphics array capture card.

FIG. 5 is a time/voltage chart illustrating a voltage step-down technique to improve signal clarity using the technique of FIG. 4.

### DETAILED DESCRIPTION

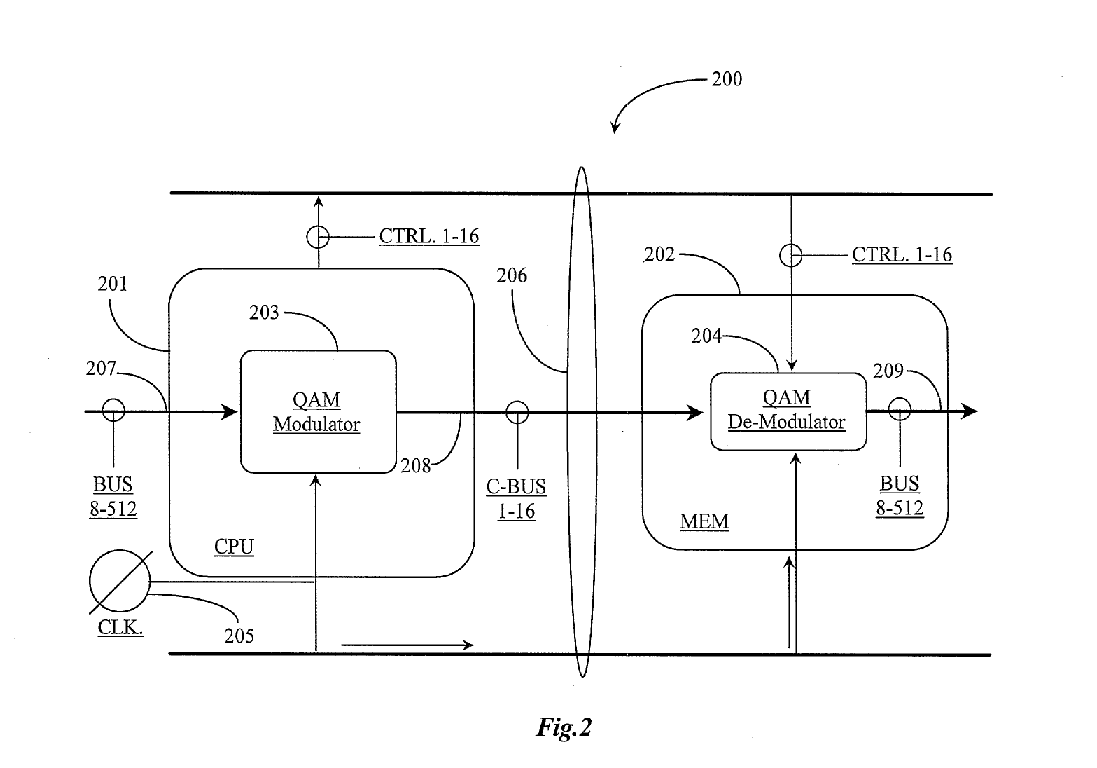

FIG. 2 is a block diagram illustrating a CPU memory bus structure and system 200 according to an embodiment of the present invention. System 200 includes a CPU 201 and a memory device 202 connected for communication by a memory bus structure 206. CPU 201 represents a resident CPU that may reside on a computer station or server station. CPU 201 may have a memory controller (not illustrated) on board. In one embodiment the memory controller may reside in between the CPU and a connected memory device like device 202.

In the present example, a front-end or local bus 206 is provided that connects memory device 202 and CPU 201 for bi-directional communication. Bus 206 is illustrated logically herein and may include peripheral bus extensions to devices other than main memory modules like peripheral component interconnect (PCI) and/or accelerated graphics port (AGP).

In a preferred embodiment of the present invention, a Quadrature Amplitude Modulation (QAM) modulator 203 is provided to CPU 201. QAM 203 is adapted to modulate parallel carrier lines to produce a reduced a reduced number of carriers. QAM modulator 203 is clocked at a high clock rate to boost output speed using a clock 205. Clock 205 may also be integrated onto CPU 201 or it may be located on the same motherboard or an adjacent board. Clock 205 is fed into QAM modulator 203 and is simultaneously distributed over bus 206.

A QAM demodulator 204 is provided on memory device 202. QAM demodulator 204 is adapted to receive a modulated signal and demodulate the signal extracting the data and rebuilding the original parallel data transmission scheme. In this simple example, a typical wide (8-512) bus 207 is fed into QAM modulator 203 on CPU 201. The carrier is modulated to reduce the number of logical data lines down to a range, perhaps 1-16 bits wide. In effect, bus 207 is compressed to occupy fewer parallel data lines during transmission. The compressed bus, the control lines, and the clock signal are bussed to memory device 202 as a modulated signal over bus 206 in this example.

QAM demodulator 204 receives compressed bus 207, the control signals, and the same clock signal used as modulator 203. QAM demodulator 204 demodulates the signals extracts the data including address data and real data, and then reconstructs bus 207 as an 8-512 bit wide bus. The system is, in actual practice, bi-directional and the advantages are that data travels at a much greater speed between the CPU and one or more memory devices. The higher clock speed forces performance levels up to the capabilities of the CPU thereby reducing the performance offset inherent with high speed CPUs and front-end bus structures.

In one embodiment of the present invention there are separate busses for input and for output between the CPU and a memory device. Auxiliary control lines can be bused directly to the memory chips in some cases. In one embodiment, the memory device 202 is a dual inline memory module. In another embodiment, device 202 may be a single inline memory module. Moreover, other types of memory devices may be represented by device 202 like a network adapter, a graphics card, or some other peripheral memory device having one or more buss addressed memory chips. In some cases more than one memory buss may come out of the CPU or memory controller. Moreover, on each bus there may be multiple memory blocks configured as a buss, configured in parallel, or configured as serial un-buffered or buffered.

In one embodiment, the lines between the CPU and memory devices may be differential lines either mono or bi-directional to enable even higher throughput rates. In some embodiments, entire local bus systems, input/output buss systems, or peripheral graphic bus systems can me modulated enabling a more compact CPU form factor. In some applications, the typical north/south bridges and memory controller chips can be entirely eliminated to help lower the system power consumption and dramatically reduce the real estate of the device.

One with skill in the art of computer bus architecture and component interconnection will appreciate that the method and apparatus of the present invention may be implemented according to variant architectures and bus types including SCSI bus, PCI bus, and AGP bus configurations and variations. The exact reduction in the number of required lines between the CPU and memory in any application is a factor of the number of original lines in the bus being compressed. The number used in the example of between 1 and 16 lines is an exemplary range only.

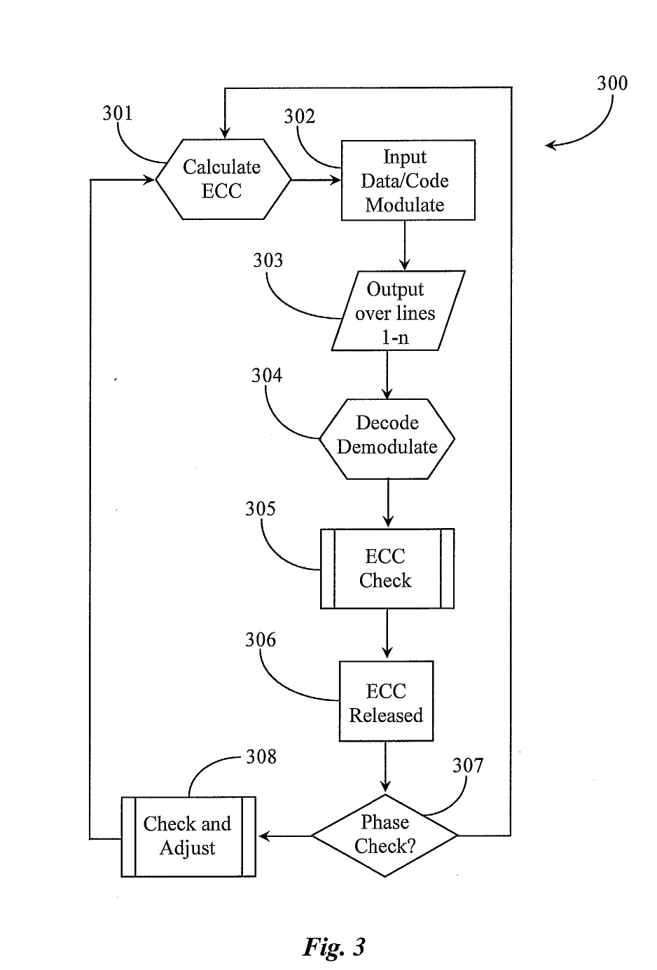

FIG. 3 is a process flow chart illustrating steps for error correction using the bus modulation system of the present invention. The bus modulation process of the present invention supports Error Correction Code (ECC). At step 301, the ECC is calculated as is known generally in the art before transmission.

At step 302, the calculated ECC is input along with the other data into the QAM modulator at the CPU. At step 303, the modulator compresses the bus reducing the number of output lines to between 1 and n lines smaller than the number of lines of the original bus. At step 304, the data and code is received over lines 1-n at the demodulator on a memory device. In this step, the data is decoded.

At step 305, the ECC check is performed and any errors found in the data are corrected. At step 306, the ECC check is released. At step 307, the system determines if a phase check will be required to determine whether the demodulator at the memory device is running at the same phase as the modulator at the CPU. This determination is made once every n cycles. Therefore, at 16, 32, or some other designated number of cycles a phase check is performed. If at step 307 the correct number of cycles has not passed, then it is determined that no phase check will be performed and the process may loop back to step 301. If step 307 falls on the correct number of cycles determined as the trigger for a phase check, then at step 308, a phase check is performed and any phase error at the memory device is corrected using techniques well known in the art of phase modulation.

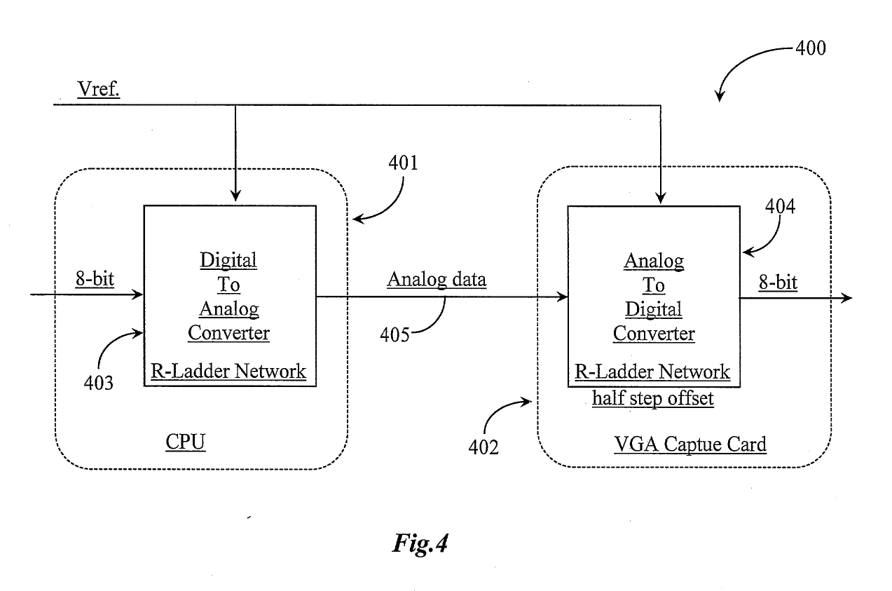

FIG. 4 is a block diagram illustrating a version of the system for implementation in a liquid crystal display example using a video graphics array capture card. In a variation of the invention described above, the inventor provides a method for transmitting data in analog between a CPU illustrated herein as CPU 401 and a memory device like a video graphics array (VGA) capture card illustrated herein as a VGA card 402.

CPU 401 may be any type of computer processor such as for example, a personal computer processor. VGA capture card 402 is a memory device that captures video graphics and formats those graphics for display on a monitor like a liquid crystal display (LCD) monitor. In this example, CPU 401 and VGA card 402 share the same voltage reference. A digital-to-analog (DAC) converter 403 is provided on CPU 401. DAC 403 is adapted to convert a digital stream to an analog signal. DAC 403 uses a network of resistors termed an R-Ladder network in the art to produce a clean analog signal.

An analog-to-digital converter (ADC) is provided on the memory device, in this case VGA capture card 402. ADC 404, like DAC 403 uses a similar R-ladder network to reconstruct a clean digital stream from the received analog signal. The inventor chooses the R-Ladder circuitry from DAC and ADC in this example because of its reliability and economic viability. There are other ways using simple circuits like capacitors, for example, to make the conversion.

In this example, there is a half step offset voltage difference in the R-Ladder network on ADC 402 created by a slightly different array of resistors caused by adding an offset resistor to the resistor network of ADC 404. The offset functions to reduce noise creating a much cleaner digital stream from the analog input. In this example, each converter is an 8-bit converter. For example, DAC 403 converts an 8-bit wide digital input into an analog stream sent to VGA card 402 over a single wire. ADC 404 receives the analog stream and converts it into an 8-bit wide digital stream for display.

As described further above, memory devices are typically slower in performance than the performance capability of the CPU. By using analog as a transfer medium the performance level is boosted at the memory device toward the performance level that the processor is capable of. The voltage threshold at the ADC 404 is offset by a half step to enable comparator circuits to more correctly determine the proper voltage range or window.

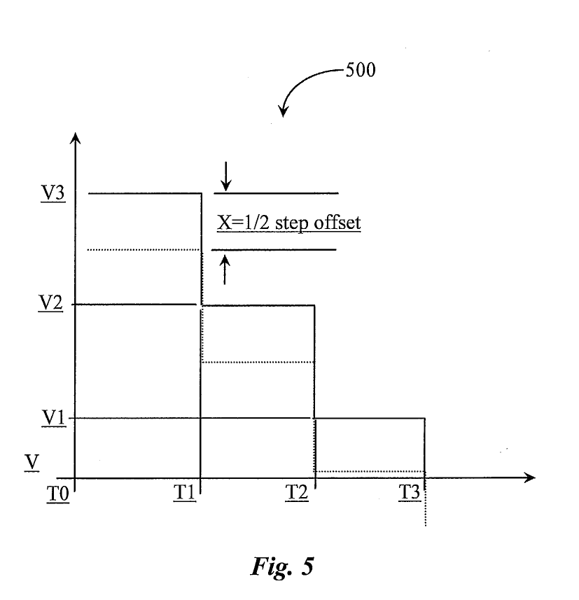

FIG. 5 is a voltage/time chart 500 illustrating the half step voltage offset at the ADC of the system of FIG. 4. Chart 500 has a voltage vector (Y axis) and a time vector (X axis). The original digital signal shown in solid line steps down in voltage from V3 to V2 between T0 and T2. In this example, the threshold is set at a voltage comparator between V2 and V3. The offset voltage is illustrated in this example as a broken line identical to the original signal but offset by one half step down. This configuration speeds up decoding of the signal to provide a fast and error free conversion back to an 8-bit wide digital stream. Likewise, by proving the same reference voltage across the bus structure to the CPU and to the memory device, voltage fluctuation and noise are better compensated.

It will be apparent to one with skill in the art that the data transmission method of the invention may be provided using some or all of the mentioned features and components without departing from the spirit and scope of the present invention. It will also be apparent to the skilled artisan that the embodiments described above are exemplary of inventions that may have far greater scope than any of the singular descriptions. There may be many alterations made in the descriptions without departing from the spirit and scope of the present invention.

What is claimed is:

1. In a computer bus architecture, a system for improving performance in data transmitting between bussed devices comprising:
a processor connected to the bus architecture;
at least one memory device bussed to the processor;
a circuit on the processor for reducing the number of bus lines required for transmitting data; and
a circuit on each of the at least one memory device for reconstructing the bussed signal.

2. The system of claim 1, wherein the processor is a central processing unit and the memory device is one or more than one of a single inline memory module or a dual inline memory module.

3. The system of claim 1, wherein the processor is a central processing unit and the memory device is one or more than one of a network adaptor, graphics accelerator port, or video graphics array capture card.

4. The system of claim 1, wherein the processor is a central processing unit and there is more than one memory device, the devices comprising a combination of dual inline memory devices and peripherally bussed memory devices.

5. The system of claim 1, wherein the processor is a central processing unit and there is more than one memory device, the devices comprising combination of single inline memory devices and peripherally bussed memory devices.

6. The system of claim 1, wherein the circuit on the processor is a quadrature amplitude modulation circuit and the circuit on the memory device is a quadrature amplitude demodulation circuit.

8. The system of claim 1, wherein the circuit on the central processor is a digital-to-analog converter and the circuit on the memory device is an analog-to-digital converter.

9. The system of claim 1, wherein phase modulation reduces the number of lines required to transmit the data.

10. The system of claim 1, wherein digital-to-analog conversion reduces the number of lines required to transmit the data.

11. In a computer bus architecture, a method for improving performance of data transmitting between bussed devices:
(a) inputting data into a bus compression circuit on one of the bussed devices;
(b) reducing the data transmission to fewer lines;
(c) transmitting data over the reduced number of lines to another of the bussed devices; and
(d) receiving the data at the device of step (c) and decompressing the bus.

12. The method of claim 11 wherein in step (a), the bus compression circuit is a quadrature amplitude modulation circuit and the device is a central processing unit.

13. The method of claim 11, wherein in step (a), the circuit is a digital-to-analog converter and the device is a central processing unit.

14. The method of claim 13, wherein in step (b), reducing the transmission to fewer lines is accomplished by phase modulation.

15. The method of claim 11, wherein in step (b), reducing the transmission to fewer lines is accomplished by digital-to-analog conversion.

16. The method of claim 11, wherein in step (c), the device is a VGA capture card with an analog to digital converter.

17. The method of claim 16, wherein in step (d), a half step voltage drop is used to clean up the signal when reconstructing the bus.

18. The system of claim 6, wherein the demodulator circuit receives the data, control signals, and a clock signal to align phase with the modulator circuit on the processor.

19. The system of claim 1, wherein the computer bus architecture includes one or a combination of a local bus, a peripheral component interconnect bus, an accelerated graphics port bus, or a Scuzzy (SCSI) bus.

20. The system of claim 3, wherein the memory device is a video display capture card having an analog-to-digital converter with a half step voltage offset for reducing noise in the reconstructed digital signal.
